(19) United States
(12) Patent Application Publication
(10) Pub. No.: US 2025/0007013 A1
(43) Pub. Date: Jan. 2, 2025

(54) CELL CONTROL BOARD AND ENERGY STORAGE SYSTEM

(71) Applicant: EVE ENERGY CO., LTD., Huizhou (CN)

(72) Inventors: Wenbing XIAO, Huizhou (CN); Zhen LIU, Huizhou (CN); Liping WAN, Huizhou (CN); Shaowei XIE, Huizhou (CN); Zhongjie LIU, Huizhou (CN)

(73) Assignee: EVE ENERGY CO., LTD., Huizhou (CN)

(21) Appl. No.: 18/759,823

(22) Filed: Jun. 29, 2024

(30) Foreign Application Priority Data
Jun. 30, 2023 (CN) 202310802619.3
Jun. 30, 2023 (CN) 202321714192.3

(51) Int. Cl. H01M 10/42; H01M 10/48

(52) U.S. Cl. CPC H01M 10/425; H01M 10/486; H01M 10/488; H01M 2010/4271; H01M 2010/4278

(57) ABSTRACT

A cell control board includes a switch device, a detection device, a communication device, and a control device connected with each of the switch device, the detection device and the communication device. The switch device has a first terminal and a second terminal respectively as a first connection terminal and a second connection terminal of the cell control board. Each of the switch device and the detection device can be connected with a cell of a battery pack, and the detection device can detect cell information of the cell. The control device is configured to: transmit the cell information to a battery pack controller through the communication device; receive control instructions therefrom; and control the switch device to adjust, based on the control instructions, connection of the cell with the remaining cells of the battery pack through the first connection terminal and the second connection terminal.

### CROSS-REFERENCE TO RELATED APPLICATIONS

This application claims the priority to Chinese Patent Application No. 202310802619.3, filed on Jun. 30, 2023, and the priority to Chinese Patent Application No. 202321714192.3, filed on Jun. 30, 2023. The disclosures of the abovementioned applications are incorporated herein by reference in their entireties.

### TECHNICAL FIELD

Embodiments of the present disclosure relate to battery technologies, and in particular, to a cell control board and an energy storage system.

### BACKGROUND

Generally, in an energy storage system, 15 or 16 cells are connected in series to form a battery module, a plurality of battery modules are connected in series to form a battery pack, and a plurality of battery packs are connected in series to form a battery cluster having a required high-voltage. The battery cluster may exchange energy with an Alternating Current (AC) power grid through an energy storage converter. In addition, each battery module or pack has a battery management slave control unit for managing the battery module or pack, and the battery cluster has a battery management master control unit for managing a plurality of battery management slave control units.

However, as the capacity and size of a single cell increase, a battery module formed by multiple cells connected in series will have a very large size and a very great weigh of hundreds of kilograms, which may make the assembly of the energy storage system inconvenient.

### SUMMARY

One or more embodiments of the present disclosure provide a cell control board, which includes a switch device, a detection device, a communication device and a control device. A first terminal of the switch device is a first connection terminal of the cell control board, and a second terminal of the switch device is a second connection terminal of the cell control board. The switch device and the detection device are both configured to be connected with a cell, the detection device is configured to detect cell information of the cell, the switch device, the detection device and the communication device are all connected with the control device, the control device is configured to transmit the cell information to a battery pack controller through the communication device, or receive one or more control instructions through the communication device, and control the switch device according to the one or more control instructions to adjust connection relationship between the cell and the remaining cells of the battery pack through the first connection terminal and the second connection terminal of the cell control board.

One or more embodiments of the present disclosure provide an energy storage system, which includes a battery pack controller, a commutator, a plurality of cells and a plurality of cell control boards. The plurality of cell control boards are connected in series through the first connection terminal and the second connection terminal, and each cell is connected to a switch device of the cell control board, and the battery pack controller and the commutator are both connected to the cell control board. The battery pack controller is configured to receive the cell information detected by the cell control board, and transmit one or more control instructions to the cell control board to adjust connection of the cell and the remaining cells of the battery pack through the first connection terminal and the second connection terminal of the cell control board, and the commutator is configured to convert Direct Current (DC) output by the cell into AC.

### BRIEF DESCRIPTION OF THE DRAWINGS

FIG. 1 is a schematic diagram of a structure of a cell control board according to one or more embodiments of the present disclosure.

FIG. 2 is a schematic diagram of another structure of a cell control board according to one or more embodiments of the present disclosure.

FIG. 3 is a schematic diagram of another structure of a cell control board according to one or more embodiments of the present disclosure.

FIG. 4 is a schematic diagram of a structure of an energy storage system according to one or more embodiments of the present disclosure.

### DETAILED DESCRIPTION

Some embodiments of the present disclosure will be described in detail below in conjunction with the accompanying drawings. The embodiments are described for illustrative purposes only and are not intended to limit the present disclosure.

It should be informed that the terms “first”, “second”, etc. in the description and claims of the present disclosure and the above drawings are used to distinguish similar objects and are not used necessarily to describe a specific sequence or order. It should be understood that the data used as such are interchangeable under appropriate circumstances so that the embodiments of the application described herein may be practiced in sequences other than those illustrated or described herein. In addition, terms “including/comprising” and “having” and any variation thereof are intended to cover non-exclusive inclusions, e.g., processes, methods, systems, products, or devices that includes a series of steps or units need not be limited to those steps or units listed clearly, instead may include other steps or units not listed clearly or inherent to those processes, methods, systems, products or devices.

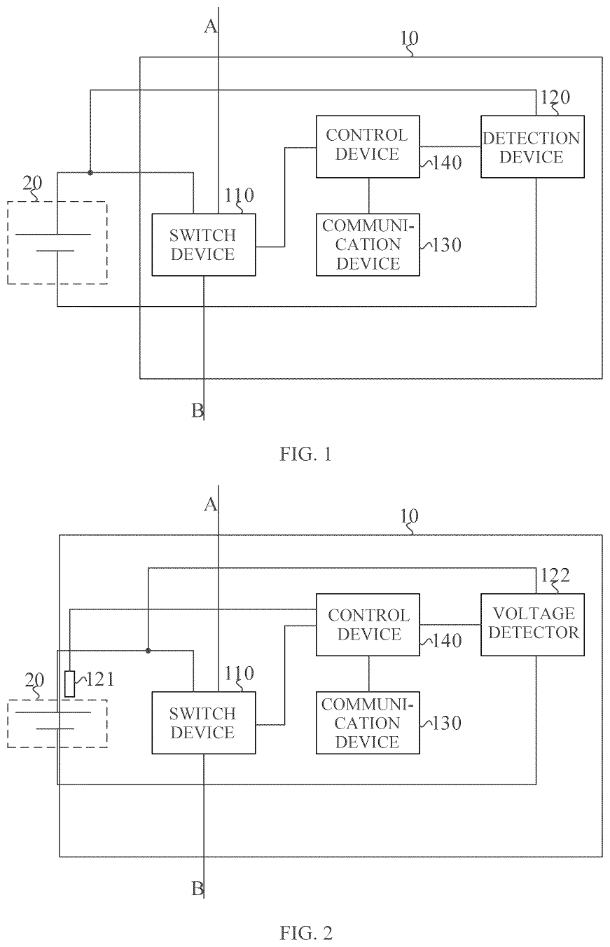

FIG. 1 is a schematic diagram of a structure of a cell control board according to one or more embodiments of the present disclosure. The cell control board 10 includes a switch device 110, a detection device 120, a communication device 130 and a control device 140. A first terminal of the switch device 110 is a first connection terminal A of the cell control board 10, and a second terminal of the switch device 110 is a second connection terminal B of the cell control board 10. The switch device 110 and the detection device 120 are both configured to connect with a cell 20, and the detect module 120 is configured to detect cell information of the cell 20. The switch device 110, the detection device 120 and the communication device 130 are all connected with the control device 140. The control device 140 is configured to transmit the cell information to a battery pack controller through the communication device 130, or receive one or more control instructions through the communication device 130, and control the switch device 110 according to the one or more control instructions to adjust connection relationship between the cell 20 and the remaining cells 20 of the battery pack through a first connection terminal A and a second connection terminal B of the cell control board 10.

The detection device 120 may detect the cell 20 to obtain the cell information. The switch device 110 may adjust connection circuit between the cell 20 and the first connection terminal A and the second connection terminal B of the cell control board 10. The communication device 130 is a channel for performing information interaction between the control device 140 and the battery pack controller. The control device 140 is an information processing and control center of the cell control board 10.

Specifically, the detection device 120 is connected with the cell 20, and may monitor the cell information of the cell 20 in real time. For example, the detection device 120 may monitor information such as temperature and voltage of the cell 20 in real time. The detection device 120 is connected with the control device 140, and may transmit the detected cell information to the control device 140. The control device 140 is connected with the communication device 130, and may communicate with the battery pack controller through the communication device 130. That is, the control device 140 transmits the cell information to the battery pack controller through the communication device 130, or receives one or more control instructions transmitted by the battery pack controller to the control device 140 through the communication device 130. The switch device 110 is connected with the control device 140 and the cell 20 respectively. The control device 140 may control a connection channel of the switch device 110 according to the received one or more control instructions, thereby adjusting connection relationship between the cell 20 and the remaining cells 20 of the battery pack through the first connection terminal A and the second connection terminal B of the cell control board 10.

In one or more embodiments of the present disclosure, the switch device 110, the detection device 120, the communication device 130 and the control device 140 are integrated into the cell control board 10, so that the battery pack controller may obtain the cell information through the cell control board 10 and control the battery, and may adjust connection relationship between the cell 20 and the remaining cells of the battery pack through the first connection terminal A and the second connection terminal B of the cell control board 10 by controlling the connection circuit between the cell 20 and the first connection terminal A and the second connection terminal B of the cell control board 10. Therefore, the battery pack integrated with the cells 20 does not need to be configured with a battery manager and an energy storage converter separately to form an energy storage system. Each cell 20 needs to be connected merely to a cell control board 10 so that connection relationship among the cells 20 of the energy storage system can be adjusted by the cell control board 10. That makes assembly of the energy storage system simpler and more convenient, and reduces design cost of the energy storage system.

Optionally, FIG. 2 is a schematic diagram of another structure of a cell control board according to one or more embodiments of the present disclosure. As shown in FIG. 2, the detection device 120 includes a temperature detector 121 and a voltage detector 122, the temperature detector 121 contacting with the cell 20 for detecting temperature information of the cell 20, the voltage detector 122 being connected with the cell 20 for detecting voltage information of the cell 20. The temperature detector 121 and the voltage detector 122 are both connected with the control device 140, which is configured to obtain the temperature information and the voltage information.

The temperature detector 121 is arranged to contact with the cell 20, and may convert thermal energy of the cell 20 into electrical energy, thereby obtaining temperature signal. The voltage detector 122 is connected between the two terminals of the cell 20, and may obtain voltage information at the two terminals of the cell 20. The temperature detector 121 and the voltage detector 122 are both connected with the control device 140. The control device 140 may obtain the temperature information detected by the temperature detector 121 and the voltage information detected by the voltage detector 122, thereby obtaining temperature and voltage of the cell 20.

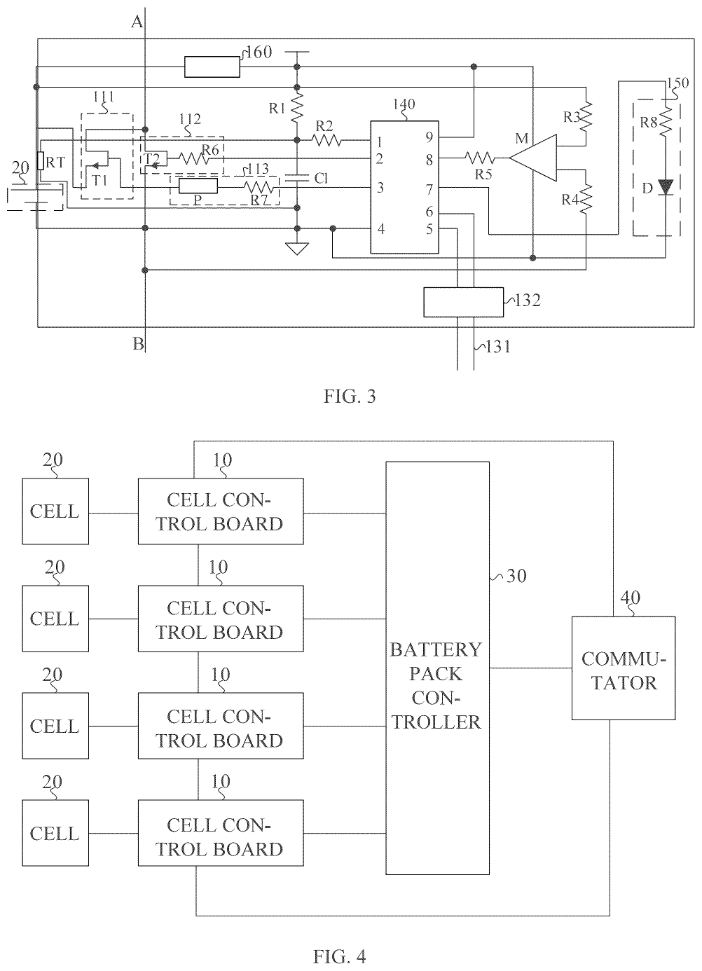

Optionally, FIG. 3 is a schematic diagram of another structure of a cell control board according to one or more embodiments of the present disclosure. As shown in FIG. 3, the temperature detector 121 includes a thermistor RT, a first resistor R1, a second resistor R2 and a first capacitor C1. The thermistor RT contacts with the cell 20. A first terminal of the thermistor RT, a first terminal of the first resistor R1 and a first terminal of the second resistor R2 are all connected with a first terminal of the first capacitor C1. A second terminal of the first resistor R1 is connected with a fixed potential. A second terminal of the second resistor R2 is connected with the control device 140. A second terminal of the thermistor RT and a second terminal of the first capacitor C1 are grounded together.

The thermistor RT may exhibit different resistance values at different temperatures, and may represent the temperature signal with electrical signal indirectly. The first resistor R1 is a pull-up resistor which may pull up potentials of the first terminal of the thermistor RT and the first terminal of the second resistor R2. The second resistor R2 has a current limiting function, which may prevent the current flowing into the control device 140 from overflowing. The first capacitor C1 has a filtering function, which may filter out clutter mixed in the electrical signal flowing into the control device 140, to make electrical signal input to the control device 140 more stable.

Optionally, continuing to refer to FIG. 3, the voltage detector 122 includes a third resistor R3, a fourth resistor R4, a fifth resistor R5 and an operational amplifier M. A first terminal of the third resistor R3 is connected with a positive terminal of the cell 20. A second terminal of the third resistor R3 is connected with a first input terminal of the operational amplifier M. A first terminal of the fourth resistor R4 is connected with a negative terminal of the cell 20. A second terminal of the fourth resistor R4 is connected with a second input terminal of the operational amplifier M. A first terminal of the fifth resistor R5 is connected with an output terminal of the operational amplifier M. A second terminal of the fifth resistor R5 is connected with the control device 140.

Specifically, according to the above connection relationship, the third resistor R3, the fourth resistor R4, the fifth resistor R5 and the operational amplifier M constitute a differential operational amplifier, which may amplify the collected voltage signal of the cell 20, so that the control device 140 may obtain more accurate voltage signal.

Optionally, continuing to refer to FIG. 3, the switch device 110 includes a first switch circuit 111, a second switch circuit 112 and an isolation circuit 113; The one or more control instructions include a first control instruction and a second control instruction. A first terminal of the first switch circuit 111 is connected with the positive terminal of the cell 20, a second terminal of the first switch circuit 111 is connected with a first terminal of the second switch circuit 112, and each of the second terminal of the first switch circuit 111 and the first terminal of the second switch circuit 112 serves as a first terminal of the switch device. A second terminal of the second switch circuit 112 is connected with the negative terminal of the cell 20 and serves as a second terminal of the switch device. A third terminal of the first switch circuit is connected with the control device 140 through the isolation circuit 113, and a third terminal of the second switch circuit 112 is connected with the control device 140.

The control device 140 is configured to control conduction of the first switch circuit 111 according to the first control instruction, so that the cell 20 is connected in series with the remaining cells of the battery pack through the first connection terminal A and the second connection terminal B of the cell control board. The control device 140 is also configured to control conduction of the second switch circuit 111 according to the second control instruction, so that the cell 20 is disconnected in series from the remaining cells of the battery pack through the first connection terminal A and the second connection terminal B of the cell control board.

Specifically, the isolation circuit 113 may isolate force electricity output from a high-voltage battery and weak electricity input to the control device 140 to improve safety of the entire cell control board 10. The control device 140 may transmit the first control instruction to the third terminal of the first switch circuit 111 through the isolation module to control conduction of the first terminal and the second terminal of the first switch circuit 111. At that time, a connecting circuit of the cell 20 with the first connection terminal A and the second connection terminal B of the cell control board 10 is conducted, so that the cell 20 is connected in series to the remaining cells of the battery pack through the first connection terminal A and the second connection terminal B of the cell control board. The control device 140 may transmit the second control instruction to the third terminal of the second control device 140 to control the first terminal and the second terminal of the second switch circuit 112 to conduct, so that the connecting circuit of the cell 20 with the first connection terminal A and the second connection terminal B of the cell control board 10 is short-circuited, thereby disconnecting the series connection of the cell 20 from the remaining cells of the battery pack through the first connection terminal A and the second connection terminal B of the cell control board.

Optionally, continuing to refer to FIG. 3, the first switch circuit 111 includes a first transistor T1, the second switch circuit 112 includes a second transistor T2 and a sixth resistor R6, and the isolation circuit 113 includes an isolation driver P and a seventh resistor R7. A first electrode of the first transistor T1 serves as a first terminal of the first switch circuit 111, a second electrode of the first transistor T1 serves as a second terminal of the first switch circuit 111, and a control terminal of the first transistor T1 serves as a third terminal of the first switch circuit 111. A first electrode of the second transistor T2 serves as a first terminal of the second switch circuit, a second electrode of the second transistor T2 serves as a second terminal of the second switch circuit 112, and a control terminal of the second transistor T2 is connected with a first terminal of the sixth resistor R6. The second terminal of the sixth resistor R6 serves as a third terminal of the second switch circuit 112, a first terminal of the isolation driver P is connected with the control terminal of the first transistor T1, a second terminal of the isolation driver P is connected with a first terminal of the seventh resistor R7, and a second terminal of the seventh resistor R7 is connected with the control device 140.

Specifically, the first electrode of the first transistor T1 is connected with the positive terminal of the cell 20, the second electrode of the first transistor T1 is connected with the first electrode of the second transistor T2, the second electrode of the second transistor T2 is connected with the negative terminal of the cell 20, the control terminal of the first transistor T1 is connected with the first terminal of the isolation driver P, the second terminal of the isolation driver P is connected with the first terminal of the seventh resistor R7, the first terminal of the seventh resistor R7 is connected with the control device. 140, the control terminal of the second transistor T2 is connected with the first terminal of the sixth resistor R6, and a second terminal of the sixth resistor R6 is connected with the control device 140.

The first transistor T1 and the second transistor T2 include one of a metal-oxide-semiconductor field effect transistor, an insulated gate bipolar transistor, a silicon carbide driving transistor and a thyristor. The sixth resistor R6 is a current limiting resistor which may prevent the second transistor T2 from being burned due to excessive input current. The seventh resistor R7 is a driving resistor of the isolation driver P, which may prevent the isolation driver P from being burned due to excessive input current.

Optionally, continuing to refer to FIG. 3, the communication device 130 includes an optical terminal 131 and an optical communication chip 132, the control device 140 being connected with the optical communication chip 132, the optical communication chip 132 being connected with the optical terminal 131.

The optical terminal 131 is an information interaction channel between the control device 140 and the battery pack controller, and the optical communication chip 132 is an information interaction exchange between the control device 140 and the battery pack controller. After the control device 140 and the battery pack controller are connected through the optical communication chip 132, the control device 140 and the battery pack controller perform information interaction through the optical terminals.

Optionally, continuing to refer to FIG. 3, the cell control board 10 further includes an indication device 150, which is connected with the control device 140. The indication device 150 is configured to indicate operating status of the control device 140.

The indication device 150 may prompt the user about current running status of the control device 140, so that the user may know current running process of the control device 140.

Specifically, the indication device 150 includes an eighth resistor R8 and a diode D, a first terminal of the eighth resistor R8 being connected with the control device 140, a second terminal of the eighth resistor R8 being connected with an anode of the diode D, a cathode of the diode D and the negative terminal of cell 20 being grounded together.

For example, when the control device 140 controls the switch device 110 to connect the cell 20 in series to a battery pack series circuit, the diode D may prompt a user by lighting up continuously; when the control device 140 controls the switch device 110 to cause the cell 20 to disconnect from the battery pack series circuit, the diode D may prompt the user by flashing slowly; and when the control device 140 obtains that the temperature of the cell 20 is too high or the cell 20 is under voltage according to the cell information, the diode D may prompt the user by flashing quickly.

It should be noted that the way in which the indication device 150 (the diode D) specifically prompts the user the current running process of the control device 140 may be adjusted according to user requirements.

Optionally, continuing to refer to FIG. 3, the cell control board 10 also includes a power module 160, which is connected with the cell 20. The control device 140, the voltage detector 122 and the temperature detector 121 are connected with the power module 160. The power module 160 may rectify voltage output by the cell 20 to provide appropriate voltages respectively to the control device 140, the voltage detector 122 and the temperature detector 121.

FIG. 4 is a schematic diagram of a structure of an energy storage system according to one or more embodiments of the present disclosure. As shown in FIG. 4, the energy storage system includes a battery pack controller 30, a commutator 40, a plurality of cells 20, and a plurality of cell control boards 10 according to any embodiment of the present disclosure.

Specifically, a plurality of cell control boards 10 are connected in series through a first connection terminal A and a second connection terminal B. Each cell 20 is connected with a switch device 110 of a cell control board 10. The battery pack controller and the commutator 40 are both connected with the cell control boards 10. The battery pack controller 30 is configured to receive cell information detected by the cell control board 10, and transmit one or more control instructions to the cell control board 10 to adjust connection between the cell 20 and the remaining cells 20 of the battery pack through the first connection terminal A and the second connection terminal B of the cell control board 10. The commutator 40 is configured to convert Direct Current (DC) power output by the cell 20 into AC power.

Specifically, each cell 20 is connected with the cell control board 10, and the cell control board 10 may collect cell information of the cell 20 and transmit the cell information to the battery pack controller 30. When the battery pack controller 30 receives the cell information detected by the cell control board 10, the battery pack controller 30 may generate one or more control instructions and transmit the one or more control instructions to the cell control board 10. The cell control board 10 may adjust connection circuit of the switch device 110 according to the one or more control instructions to adjust the connection between the cell 20 and the remaining cells 20 of the battery pack through the first connection terminal A and the second connection terminal B of the cell control board 10. The head terminal and the tail terminal of the series circuit of a plurality of cell control boards 10 are connected with the commutator 40. The respective cells 20 which realize series connection through the cell control boards 10 connected respectively may simultaneously supply DC to the commutator 40 so that the commutator 40 converts DC power output from the cells 20 connected in series into AC power.

It should be understood that various forms of the process above shown may be used, where steps may be reordered, added or deleted. For example, respective steps described in the present disclosure may be performed in parallel, sequentially, or in different orders, as long as the desired results of the technical solution of the present disclosure may be achieved, and there is no limitation herein.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. A cell control board, comprising a switch device, a detection device, a communication device, and a control device connected with each of the switch device, the detection device and the communication device,
wherein the switch device has a first terminal as a first connection terminal of the cell control board, and a second terminal as a second connection terminal of the cell control board;
each of the switch device and the detection device is configured to be connected with a cell of a battery pack, and the detection device is configured to detect cell information of the cell; and
the control device is configured to: transmit the cell information to a battery pack controller through the communication device; receive one or more control instructions from the battery pack controller through the communication device; and control the switch device to adjust, based on the one or more control instructions, connection of the cell with one or more cells of the battery pack other than the cell through the first connection terminal and the second connection terminal.

2. The cell control board according to claim 1, wherein the detection device comprises a temperature detector and a voltage detector;
the temperature detector is configured to contact the cell to detect a temperature of the cell to obtain temperature information;
the voltage detector is configured to be connected with the cell to detect a voltage of the cell to obtain voltage information;
both the temperature detector and the voltage detector are connected with the control device; and
the control device is configured to obtain the temperature information and the voltage information as the cell information.

3. The cell control board according to claim 2, wherein the temperature detector comprises a thermistor, a first resistor, a second resistor and a first capacitor;
the thermistor is configured to contact the cell;
each of a first terminal of the thermistor, a first terminal of the first resistor, and a first terminal of the second resistor is connected with a first terminal of the first capacitor;
a second terminal of the first resistor is connected with a node having a fixed potential;
a second terminal of the second resistor is connected with the control device; and
each of a second terminal of the thermistor and a second terminal of the first capacitor is grounded.

4. The cell control board according to claim 2, wherein the voltage detector comprises a third resistor, a fourth resistor, a fifth resistor and an operational amplifier;
a first terminal of the third resistor is configured to be connected with a positive terminal of the cell, and a second terminal of the third resistor is configured to be connected with a first input terminal of the operational amplifier;
a first terminal of the fourth resistor is configured to be connected with a negative terminal of the cell, and a second terminal of the fourth resistor is configured to be connected with a second input terminal of the operational amplifier; and
a first terminal of the fifth resistor is configured to be connected with an output terminal of the operational amplifier, and a second terminal of the five resistor is configured to be connected with the control device.

5. The cell control board according to claim 1, wherein the switch device comprises a first switch circuit, a second switch circuit and an isolation circuit;
the one or more control instructions comprise a first control instruction and a second control instruction;
a first terminal of the first switch circuit is configured to be connected with a positive terminal of the cell, a second terminal of the first switch circuit is configured to be connected with a first terminal of the second switch circuit, and each of the second terminal of the first switch circuit and the first terminal of the second switch circuit serves as the first terminal of the switch device;
a second terminal of the second switch circuit is configured to be connected with a negative terminal of the cell and serves as the second terminal of the switch device;
a third terminal of the first switch circuit is configured to be connected with the control device through the isolation circuit, and a third terminal of the second switch circuit is configured to be connected with the control device;
the control device is configured to control the first switch circuit to be turned on based on the first control instruction, so that the cell is connected in series with the one or more cells through the first connection terminal and the second connection terminal; and
the control device is further configured to control the second switch circuit to be turned on based on the second control instruction, so that the cell is not connected in series with the one or more cells through the first connection terminal and the second connection.

6. The cell control board according to claim 5, wherein the first switch circuit comprises a first transistor;
the second switch circuit comprises a second transistor and a sixth resistor;
the isolation circuit comprises an isolation driver and a seventh resistor;
a first electrode of the first transistor serves as the first terminal of the first switch circuit, a second electrode of the first transistor serves as the second terminal of the first switch circuit, and a control terminal of the first transistor serves as the third terminal of the first switch circuit;
a first electrode of the second transistor serves as the first terminal of the second switch circuit, a second electrode of the second transistor serves as the second terminal of the second switch circuit, a control terminal of the second transistor is configured to be connected with a first terminal of the sixth resistor, and a second terminal of the sixth resistor serves as the third terminal of the second switch circuit; and
a first terminal of the isolation driver is configured to be connected with the control terminal of the first transistor, a second terminal of the isolation driver is configured to be connected with a first terminal of the seventh resistor, and a second terminal of the seventh resistor is configured to be connected with the control device.

7. The cell control board according to claim 1, wherein the communication device comprises an optical terminal and an optical communication chip connected with the optical terminal; and
the control device is configured to be connected with the optical communication chip.

8. The cell control board according to claim 1, further comprising an indication device connected with the control device to indicate an operation state of the control device.

9. The cell control board according to claim 8, wherein the indication device comprises an eighth resistor and a diode;
a first terminal of the eighth resistor is configured to be connected with the control device, and a second terminal of the eighth resistor is configured to be connected with an anode of the diode; and
a cathode of the diode is grounded.

10. An energy storage system, comprising a battery pack controller, a commutator, a plurality of cells, and a plurality of cell control boards,
wherein each of the cell control boards comprises a switch device, a detection device, a communication device, and a control device connected with each of the switch device, the detection device and the communication device;
the switch device has a first terminal as a first connection terminal of the each of the cell control boards, and a second terminal as a second connection terminal of the each of the cell control boards;
the cell control boards are connected in series through the first connection terminal and the second connection terminal;
both the battery pack controller and the commutator are connected with the cell control boards;
the commutator is configured to convert DC power output by each of the cells into AC power;
each of the switch device and the detection device is connected with one of the cells, and the detection device is configured to detect cell information of the one of the cells; and
the control device is configured to: transmit the cell information to the battery pack controller through the communication device; receive one or more control instructions from the battery pack controller through the communication device; and control the switch device to adjust, based on the one or more control instructions, connection of the one of the cells with one or more of the cells other than the one of the cells through the first connection terminal and the second connection terminal.

11. The energy storage system according to claim 10, wherein the detection device comprises a temperature detector and a voltage detector;
the temperature detector is configured to contact the one of the cells to detect a temperature of the one of the cells to obtain temperature information;
the voltage detector is configured to be connected with the one of the cells to detect a voltage of the one of the cells to obtain voltage information;
both the temperature detector and the voltage detector are connected with the control device; and
the control device is configured to obtain the temperature information and the voltage information as the cell information.

12. The energy storage system according to claim 11, wherein the temperature detector comprises a thermistor, a first resistor, a second resistor and a first capacitor;
the thermistor is configured to contact the one of the cells;
each of a first terminal of the thermistor, a first terminal of the first resistor, and a first terminal of the second resistor is configured to be connected with a first terminal of the first capacitor;
a second terminal of the first resistor is configured to be connected with a node having a fixed potential;
a second terminal of the second resistor is configured to be connected with the control device; and
each of a second terminal of the thermistor and a second terminal of the first capacitor is grounded.

13. The energy storage system according to claim 11, wherein the voltage detector comprises a third resistor, a fourth resistor, a fifth resistor and an operational amplifier;
a first terminal of the third resistor is configured to be connected with a positive terminal of the one of the cells, and a second terminal of the third resistor is configured to be connected with a first input terminal of the operational amplifier;
a first terminal of the fourth resistor is configured to be connected with a negative terminal of the one of the cells, and a second terminal of the fourth resistor is configured to be connected with a second input terminal of the operational amplifier; and
a first terminal of the fifth resistor is configured to be connected with an output terminal of the operational amplifier, and a second terminal of the five resistor is configured to be connected with the control device.

14. The energy storage system according to claim 10, wherein the switch device comprises a first switch circuit, a second switch circuit and an isolation circuit;
the one or more control instructions comprise a first control instruction and a second control instruction;
a first terminal of the first switch circuit is configured to be connected with a positive terminal of the one of the cells, a second terminal of the first switch circuit is configured to be connected with a first terminal of the second switch circuit, and each of the second terminal of the first switch circuit and the first terminal of the second switch circuit serves as the first terminal of the switch device;
a second terminal of the second switch circuit is configured to be connected with a negative terminal of the one of the cells and serves as the second terminal of the switch device;
a third terminal of the first switch circuit is configured to be connected with the control device through the isolation circuit, and a third terminal of the second switch circuit is configured to be connected with the control device;
the control device is configured to control the first switch circuit to be turned on based on the first control instruction, so that the one of the cells is connected in series with the one or more of the cells through the first connection terminal and the second connection terminal; and
the control device is further configured to control the second switch circuit to be turned on based on the second control instruction, so that the one of the cells is not connected in series with the one or more of the cells through the first connection terminal and the second connection.

15. The energy storage system according to claim 14, wherein the first switch circuit comprises a first transistor;
the second switch circuit comprises a second transistor and a sixth resistor;
the isolation circuit comprises an isolation driver and a seventh resistor;
a first electrode of the first transistor serves as the first terminal of the first switch circuit, a second electrode of the first transistor serves as the second terminal of the first switch circuit, and a control terminal of the first transistor serves as the third terminal of the first switch circuit;
a first electrode of the second transistor serves as the first terminal of the second switch circuit, a second electrode of the second transistor serves as the second terminal of the second switch circuit, a control terminal of the second transistor is configured to be connected with a first terminal of the sixth resistor, and a second terminal of the sixth resistor serves as the third terminal of the second switch circuit; and
a first terminal of the isolation driver is configured to be connected with the control terminal of the first transistor, a second terminal of the isolation driver is configured to be connected with a first terminal of the seventh resistor, and a second terminal of the seventh resistor is configured to be connected with the control device.

16. The energy storage system according to claim 10, wherein the communication device comprises an optical terminal and an optical communication chip connected with the optical terminal; and
the control device is configured to be connected with the optical communication chip.

17. The energy storage system according to claim 10, wherein the each of the cell control boards further comprises an indication device connected with the control device to indicate an operation state of the control device.

18. The energy storage system according to claim 17, wherein the indication device comprises an eighth resistor and a diode;
a first terminal of the eighth resistor is configured to be connected with the control device, and a second terminal of the eighth resistor is configured to be connected with an anode of the diode; and
a cathode of the diode is grounded.
